(19) United States
(12) Patent Application Publication
(10) Pub. No.: US 2014/0126770 A1
(43) Pub. Date: May 8, 2014

(54) PHR/EMR Retrieval System Based on Body Part Recognition and Method of Operation Thereof

(71) Applicants: Adam Odessky, San Francisco, CA (US); Sheshadri Amathnadu, Santa Clara, CA (US)

(72) Inventors: Adam Odessky, San Francisco, CA (US); Sheshadri Amathnadu, Santa Clara, CA (US)

(73) Assignee: France Telecom, Paris (FR)

(21) Appl. No.: 13/990,671

(22) PCT Filed: Nov. 28, 2011
(86) PCT No.: PCT/IB2011/003191

§ 371 Date: Dec. 17, 2013

Related U.S. Application Data
(60) Provisional application No. 61/418,395, filed on Nov. 30, 2010.

(51) Int. Cl. G06F 19/00; G06F 17/30; G06K 9/00

(52) U.S. Cl. CPC G06F 19/321; G06K 9/00362; G06F 17/30259
USPC 382/103

(57) ABSTRACT

A method of filtering an electronic medical record (EMR) based on a selected body part (SBP). The method may be controlled by one or more controllers and may include one or more acts of obtaining image information of a patient, analyzing the image information using an object recognition method, identifying a SBP of the patient based upon the analyzing of the image information, and filtering the EMR of the patient in accordance with the SBP.

### FIELD OF THE PRESENT SYSTEM

The present system relates generally to a technique for obtaining information related to a user, and more specifically to a gesture driven medical record system to obtain electronic medical records related to a user.

### BACKGROUND OF THE PRESENT SYSTEM

Typically, medical records for a patient are kept at the patient's doctor's office in soft or hard copy form. Accordingly, access to the records may be difficult outside of the doctor's office which may be critical at times such as may occur during an emergency-room visit. Further, although there have been attempts to unify all medical records in an electronic database that may be accessed by medical is professionals such as doctors. However, these systems may allow access by a medical professional to medical records which may not be related to a current condition or may not be relevant to the medical professional. Accordingly, patients may find conventional medical record access systems intrusive on their privacy.

### SUMMARY OF THE PRESENT SYSTEM

The present system discloses a system, method, apparatus, user interface (UI), and computer program portion (hereinafter each of which may be referred to as system unless the context indicates otherwise) suitable to obtain, process, and/or render information related to the user (e.g., a patient) such as medical records in accordance with a user's gestures. Accordingly, information related to the users gestures (e.g., with respect to one or more body parts) may be accessed while data which is determined not be related to the user's gestures may be denied access and may remain secured.

Accordingly, it is an aspect of the present system to disclose a method for associating a person's EMR or PHR information with a specific body part, body parts, or area (e.g., lower abdomen), for retrieval at a later time.

In accordance with an aspect of the present system, there is disclosed a system which may recognize a user such as a patient and a gesture associated with a body part or parts of the user. Then, the system may user this information to obtain electronic medical records (EMRs) and/or personal health records (PHRs) that correspond with the user (e.g., a patient) and the identified gesture. Thus, if the gesture is determined to be associated with a user's ankle, medical information related to the users ankle or associated region may be accessed and displayed by the system for user (e.g., for use by a professional, etc.) while medical information related to the users head (e.g., dental records, vision records, psychological records, etc.) may be denied access. Thus, a professional such as a doctor, etc., may quickly and conveniently access medical information (e.g., records, etc.) of the user that is determined to be associated with a region of interest (ROI) of the user, while medical information of the user which is not determined to be associated with the ROI is not accessed by the medical professional unless specifically requested. Thus, a medical professional may not have to filter irrelevant medical records which may save time and reduce medical cost. However, the system may also provide methods for a medical professional to access other records when specifically requested and/or access requirements are met.

In accordance with an aspect of the present system, there is disclosed a method of retrieving an electronic medical record (EMR) and/or a personal health record (PHR) related to a user. The method controlled by one or more controllers and include one or more acts of obtaining image information of the user; analyzing the image information using an object recognition method, identifying a selected body part of the user based upon the analyzing of the image information, and retrieving EMR/PHR information of the user in accordance with the selected body part.

The method may further include an act of providing the retrieved EMR/PHR information to a requesting user station (US). Further, the method may include an act of retrieving in accordance with a privacy setting of the user. According to the method, the privacy settings may include settings related to one or more of the selected body part and an accessor. Further, the act of identifying may be further performed in accordance with a determined relationship between two or more body parts of the user.

Moreover, according to an embodiment of the method, the act of determining the relationship may further include acts of recognizing a plurality of body parts of the user from the image information using an optical recognition technique, and/or determining an association between two or more of the recognized body parts. Moreover, the method may include an act of rendering the selected medical information on a display. The method may further include an act of determining whether the user is a registered user based upon a biometric analysis of features of the user, and/or obtaining privacy settings of the user from a memory of the system.

In accordance with yet another aspect of the present system, there is disclosed a system to retrieve electronic medical record (EMR) and/or personal health record (EMR/PHR) information. The EMR/PHR system may be stored in a memory of the system and may include EMR/PHR information for a plurality of users. The system may include a processor portion which may obtain image information of a user of the plurality of users, analyze the image information using an object recognition method, identify a selected body part of the user based upon the analyzing of the image information, and/or retrieve the EMR/PHR information of the user in accordance with the selected body part.

In accordance with an embodiment of the system, the processing portion may provide the retrieved EMR/PHR information to a requesting user station (US) of an accessor. Moreover, the processing portion may retrieve the EMR/PHR information of the user in accordance with a privacy setting of the user. Further, the processing portion may obtain privacy settings related to one or more of the selected body part and an accessor. It is further envisioned that the processing portion may determine a relationship between two or more body parts of the user, and/or identify the selected body part based upon the determined relationship.

Further, it is envisioned that the processing portion may recognize a plurality of body parts of the user from the image information using an optical recognition technique, determine an association between two or more of the recognized body parts, and/or determine the relationship based upon the determined association between the two or more recognized body parts.

The system may further include a display which may render the selected medical information. In accordance with yet other embodiments of the present system, the processing portion may perform a biometric analysis of features of the user, and/or may determine whether the user is a registered user based upon the biometric analysis.

In accordance with yet another aspect of the present system, there is disclosed a computer program stored on a non-transitory computer readable memory medium, the computer program may be configured to retrieve electronic medical record (EMR) and personal health record (EMR/PHR) information. The computer program may include a program portion which may be configured to obtain image information of a user, analyze the image information using an object recognition method, identify a selected body part of the user based upon the analyzing of the image information, and/or retrieve the EMR/PHR information of the user in accordance with the selected body part.

The program portion may also be configured to provide the retrieved EMR/PHR information to a requesting user station (US) of an accessor. It is further envisioned that the program portion may be configured to retrieve the EMR/PHR information of the user in accordance with a privacy setting of the user (e.g., a patient). The program portion may further be configured to obtain privacy settings related to one or more of the selected body part and an accessor. It is further envisioned that the program portion may be configured to determine a relationship between two or more body parts of the user, and/or identify the selected body part based upon the determined relationship.

In accordance with yet other embodiments of the present system, it is envisioned that the program portion may be configured to recognize a plurality of body parts of the user from the image information using an optical recognition technique, determine an association between two or more of the recognized body parts, and/or determine the relationship based upon the determined association between the two or more recognized body parts. Moreover, the program portion may be configured to render the selected medical information on display. It is also envisioned that the program portion may be configured to perform a biometric analysis of features of the user, and/or determine whether the user is a registered user based upon the biometric analysis. The system may identify an accessor via a login request (Doctor John E. Doe, Jane Doe, etc.), by location (e.g., in a hospital), by organization (e.g., doctors office, hospital, clinic, etc.), by accessing user station (US), a biometric analysis, an application type (e.g., a medical viewing application vs. a billing application, etc.), etc.

According to yet a further aspect of the present system, there is disclosed a method of filtering electronic medical record (EMR)/personal health record (PHR) information of a user, the method may include one or more acts of determining a selected body part of the user, obtaining a privacy setting of the user, the privacy setting including privacy settings related to the selected body part of the user, and filtering the EMR/PHR information in accordance with the selected body part and the privacy setting of the user.

According to the method, the act of filtering the EMR/PHR information may include an act of forming a query in accordance with the determined body part of the user and the privacy setting of the user. Moreover, the act of filtering the EMR/PHR information may include querying an EMR/PHR database in accordance with the formed query. Moreover, the act of filtering the EMR/PHR information may also include receiving results of the query and forwarding the results of the query to one or more selected user stations.

### BRIEF DESCRIPTION OF THE DRAWINGS

The present system is explained in further detail, and by way of example, with reference to the accompanying drawings wherein:

FIG. 1 shows a block diagram of a portion of an imaging system in accordance with embodiments of the present system;

FIG. 2 shows a screen shot of an image of an individual (e.g., a user) captured in accordance with embodiments of the present system;

FIG. 3 shows an image rendered using SOI in accordance with embodiments of the present system;

FIG. 4 shows a flow diagram that illustrates a process in accordance with embodiments of the present system;

FIG. 5 shows a flow diagram that illustrates a process in accordance with embodiments of the present system;

FIG. 6 shows an illustrative mapping of EMR/PHR records to body parts of a user in accordance with embodiments of the present system;

FIG. 7 shows a mapping of privacy settings to body parts of a user in accordance with embodiments of the present system;

FIG. 8 shows a portion of a system in accordance with embodiments of the present system; and

FIG. 9 shows a portion of a system (e.g., peer, server, etc.) in accordance with embodiments of the present system.

### DETAILED DESCRIPTION OF THE PRESENT SYSTEM

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection (e.g., cellular network, Wi-Fi, network, etc.) between two or more devices that enables a one and/or two-way communication path between the devices and/or portions thereof, such as an operative coupling through a network.

The term rendering and formatives thereof as utilized herein refer to providing content, such as digital media which may include, for example, a EMR/PHR information, image information, information generated and/or accessed by the present system, messages, status information, settings, audio information, audiovisual information, etc., such that it may be perceived by at least one user sense, such as a sense of sight and/or a sense of hearing. For example, the present system may render a user interface (UI) on a display device so that it may be seen and interacted with by a user.

An EMR (electronic medical record), PHR (personal health record), etc. is a computerized medical record which is organized (i.e., divided) per users (e.g., patients) and typically contains complete medical information for each such patient. The EMR/PHR typically includes detailed information including clinical documents, lab reports, images (e.g., x-ray, CT scan, MRIs, etc.), trend data, monitoring data etc. Typically these records are created in an organization that delivers care, such as a hospital, doctors office, dentist office etc., although may also include records from non-medical facilities such as insurance offices etc. To simplify the following discussion, the term EMR will be utilized to include any such electronic data source that is organized and retrievable with regard to given users. In fact, an EMR is actually made up of many individual records related to the patient. Discussions herein will utilize terms such as EMR portions to discuss a filtered retrieval of the EMR in accordance with embodiments of the present system. Further, the user related to a given EMR will be termed herein a patient, although as may be readily appreciated, any user that has associated EMRs may benefit in accordance with embodiments of the present system.

The problem with the EMR is that it may include a vast amount of information related to a patient, only some of which may be relevant for any given situation, such as to a medical practitioner treating the patient. Further, for privacy reasons, a patient may not desire a given practitioner or other party to have access to the entire EMR.

In accordance with embodiments of the present system, EMR retrieval is greatly simplified by providing a system, method, etc., including a retrieval portion that retrieves (e.g., filters) the EMR in accordance with one or more selected body part (SBPs) of the patient to a filtered EMR that includes only a portion of the EMR that are determined by the system to be related to the SBPs of the patient. In accordance with embodiments of the present system, the filtered EMR may then be provided to one or more requesting stations that meet privacy criteria described further herein and/or may be rendered on a user interface (UI) of the system such as a display device, a speaker, etc. In this way, the filtered EMR may be suitably utilized by, for example, a medical professional such as a doctor, a technician, a nurse, etc., while access to other portions of the patient's EMR will be restricted from access.

In accordance with embodiments of the present system, the SBP acts as a key to access related patient information (e.g., such as EMR portions of a “body subsystem”). In this way, the EMR may be accessed via “recognized body subsystems” which may include the body parts (e.g., leg, arm, chest, etc.), organs of the body (e.g., brain, heart, kidney, skin, etc.), systems such as respiratory, cardiovascular, nervous, internal system structures (e.g., bones), etc. In accordance with other embodiments of the present system, an image recognition system may be utilized to recognize internal system structures like bones, organs, etc. In this way, depending on the type of imaging/recognition system utilized, different body subsystems may be recognized to access associated EMR. For simplifying the following discussion, the term selected body part, SBP and formatives thereof should be understood to include any recognizable body subsystem including a selected body part, body region (e.g., a hip region, a shoulder region, etc.), underlying body system (e.g., lymphatic, respiratory, cardiovascular, nervous etc.), organ, internal system structures and/or other body subsystem, unless a particular part, system, etc. is specified.

Accordingly, by providing filtered EMR information based on the SBP, a medical professional may quickly and conveniently retrieve relevant medical information of the patient without the need for retrieving an entire unfiltered EMR. In this way, the present system may save time and reduce costs associated with viewing/retrieving the patients EMR. Further, patient privacy may be enhanced by providing only a filtered EMR which are related to a particular body part of the patient such as a SBR and not the entire EMR related to the patient. Accordingly, access to a portion of the EMR which is not determined to be related to the SBR may be prevented. Naturally, the filtering may be overridden by the patient to provide other portions of the EMR if desired.

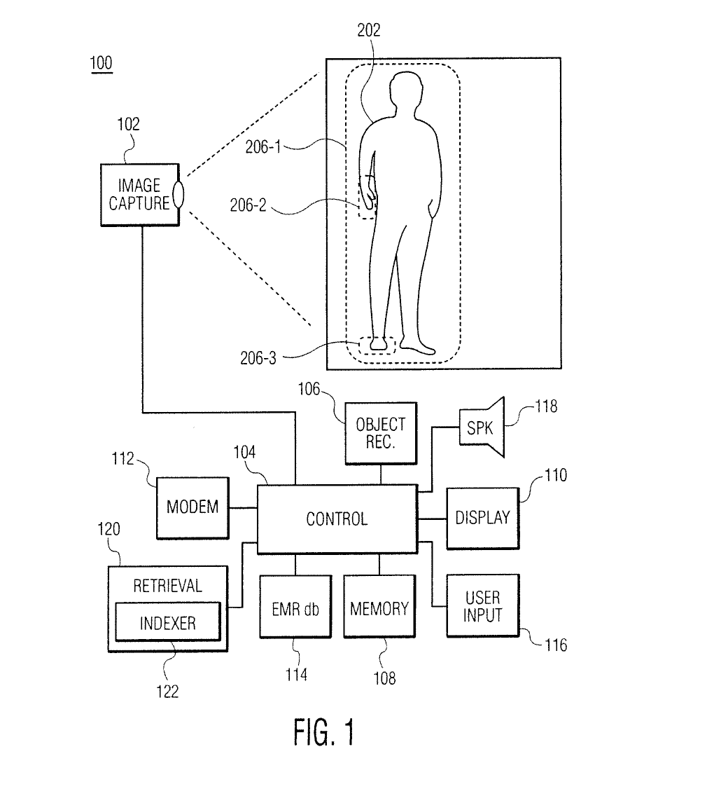

FIG. 1 shows a block diagram of a portion of an imaging system 100 in accordance with embodiments of the present system. The imaging system 100 may include one or more of an image capture portion 102, an object recognition portion 106, a memory portion 108, a display portion 110, a modem 112, a EMR/PHR database (DB) portion 114, a user input portion 116, a speaker (SPK) 118, and a retrieval portion 120 including an indexer 122, each of which is shown operatively coupled to a control portion 104. As may be readily appreciated, each portion is shown separated from each other portion for purposes of simplifying the following discussion although in physical form, may be separate from, and/or combined, such as for example, the control portion 104 and the object recognition portion 106 which may be operable parts of a device such as a processor. Further, each of the portions 102-122 may be operative coupled locally (e.g., within a local area network) or remotely (e.g., through a wide area network) from each other. Accordingly, each of portions 102-122 may communicate with other portions 102-122 via, for example, a wired or wireless network such as the Internet, a personal area network, a local area network, a wide area network, a peer-to-peer network, a local communication portion (e.g., a motherboard), etc.

The image capture portion 102 may include any suitable image capture device such as, for example, a camera, a video camera, a live stream, an x-ray device, computed tomography (CT scan), electro-magnetic imaging device, and/or other imaging system, which may provide one or more images of one or more patients such as a patient 202. Accordingly, the image capture portion 102 may be any type of imaging system including a camera embedded in another device (e.g., a phone camera) that may capture still images, a sequence of images, video images, etc., of the patient 202 as image information. The image capture portion 102 may include a web camera which may transmit image information to the control portion 104 for further processing.

The control portion 104 may control the overall operation of the imaging system 100 and may include one or more processors, logic devices, controllers, processors, application specific integrated circuits (ASICs), logic arrays, shifters, etc., which when suitably programmed, configured, etc., may process, transmit and/or receive information (e.g., image information, control and/or command information, etc.).

The object recognition portion 106 may include a digital signal processor (DSP) which may process the raw image information in accordance with one or more algorithms of the present system. The algorithms may be part of, for example, one or more image processing applications such as an OpenCV™ application. The object recognition portion 106 may comprise hard (e.g., hardware) and/or soft (e.g., software) processing portions. The object recognition portion 106 may receive the image information from the image capture portion 102 via the control portion 104 or directly and may process the image information in accordance with one or more is object recognition methods such as the Open CV HaarCascades-type method to identify various body parts of the user such as a head, face, arm (e.g., left, right), leg (e.g., left right), stomach, chest, shoulder (e.g., left, right), etc., and form corresponding object recognition information (ORI). In accordance with embodiments of the present system, the object recognition portion 106 may determine a selected body part (SBP) of a patient. The ORI may be forwarded to the control portion 104 and/or stored in the memory 108 of the system 100 for later use, such as for retrieving a portion of a EMR related to the SBP. As may be readily appreciated, other systems, methods, algorithms, etc., may be suitably applied for determining the SBP. For example, U.S. patent application Ser. No. ______ (Attorney Docket No. FT07842) describes a system for body part recognition, incorporated herein in its entirety, which may be suitably employed by the object recognition portion 106 in accordance with embodiments of the present system.

The memory 108 may include any suitable device in which various information of the imaging system 100 may be stored. Accordingly, the memory 108 may include a non-transitory memory which may store image information, such as ORI generated by the system 100, user information (e.g., user account information, registration information, etc.), operating programs or applications of the present system (e.g., such as those run by the control portion 104 and/or the object recognition portion 106), and/or other information of the present imaging system 100. The memory 108 may include non-transitory portions which are located locally and/or remotely from each other. Accordingly, the memory 108 may include a surface area network (SAN) or the like. Moreover, the memory 108 may be accessible via a local connection or remotely over a network.

The EMR/PMR database portion 114 may include a medical information memory (MIM) of the system and may therefore include EMRs of one or more users and may be located in one or more locations, local and/or remote from each other. The MIM may include a distributed memory which may include medical records of one or more medical providers such as doctors, hospitals, etc., health professionals (e.g., chiropractors, psychologists, acupuncturists, etc.), insurance companies, organizations, national medical databases, private medical records (e.g., medical records of a patient stored on a private memory of the patient), etc., which may individually and/or collectively form an EMR of one or more patients. Thus, the system 100 may query a plurality of medical information databases to obtain medical records of the user. The EMR/PMR database portion 114 may be queried (e.g., accessed) by the present system 100 to obtain a filtered EMR in accordance with one or more SBPs, body region(s) and/or privacy settings of a corresponding user, and may transmit results of the query to the control portion 104 for further processing.

The display portion 110 may include any suitable display which may display the EMR and/or other information. Accordingly, the display 110 may include a liquid crystal display (LCD), a light emitting diode (LED) display, a cathode ray tube (CRT) display, an electrophoretic (EA) display, etc., which may display information related to the present system. The display portion 110 may include a touch-screen display with which a user may interact with the system 100. In this way, the display portion 110 may operate as the user input portion 116 or as a portion thereof.

The user input portion 116 may include an input device with which a user may enter commands such as a keyboard, a microphone, pointing device (e.g., a stylus, a mouse, etc.), a touch-screen display, etc., to input information such as user selections, commands, etc., and may transmit information input by the user to the control portion 104 for further processing. The speaker 118 may render audio information under the control of the control portion 104 and may render audio content. Accordingly, the speaker 118 may receive information from, for example, an audio coder decoder (CODEC) and audibly output the received information to facilitate interaction.

The modem portion 112 may comprise a wired and/or wireless modem which may transmit and/or receive information such as command and/or control information, image information, data (e.g., emails, short messages service (SMS) messages, files), audio and/or video content, etc., using any suitable protocol. Accordingly, the modem 112 may be configured to upconvert information for transmission via a wired and/or wireless link (e.g., via an antenna, etc.) and may downconvert information received from the antenna and relay the downconverted information to the control portion 104.

The retrieval portion 120, together with the control portion 104 and the EMR to database 114 is utilized for retrieving the filtered EMR as described further herein. The indexer 122 may be utilized to index the EMR based on the SBP (e.g., based on a selected body part, body region, underlying body system, etc.) to facilitate retrieval of the filtered EMR based on the SBP. In accordance with embodiments of the present system, the indexer 122 may be utilized to mine medical records of one or more patients from one or more external memories (e.g., insurance record, hospital records, doctor's records, national medical database records, etc.) and form a corresponding indexed EMR which, for example, may be stored in the EMR database 114. In other embodiments, the indexer 122 may simply provide an index of the EMR based on SBPs including an identification of the location for later retrieval. It is also envisioned by the present system that the EMR or portions thereof may be obtained in real time from a system that generates one or more portions of the EMR, such as an x-ray device, etc. and that these portions are also indexed by SBPs.

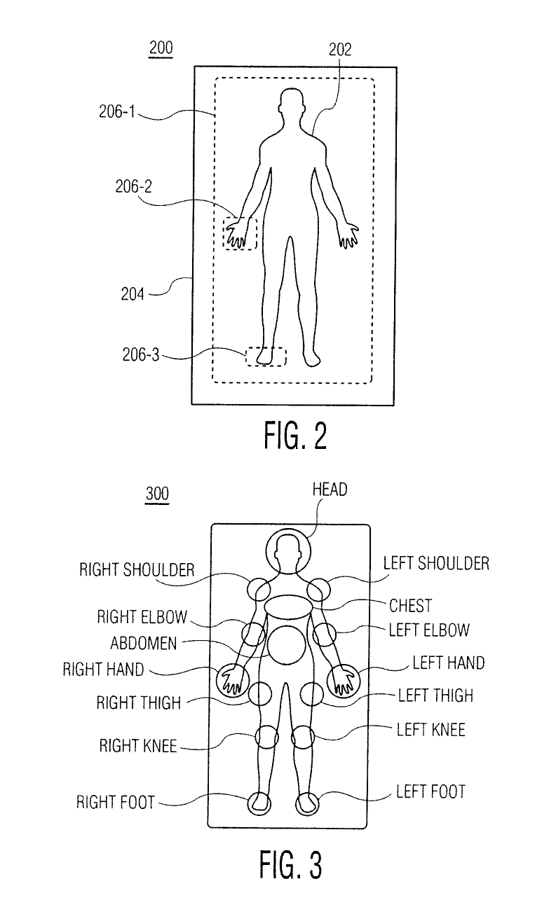

FIG. 2 shows a screen shot of an image 200 of an individual (e.g., a user) captured in accordance with embodiments of the present system. The image 200 is captured by an image capture portion (e.g., 102 etc.) and processed by an object recognition portion (e.g., see, 106) which may process the image 200 using one or more object recognition methods such as, an OpenCV™ HaarCascades method or other suitable object recognition method such as a DSP method, etc., to identify relevant portions (e.g., one or more SBPs) of the image 200. The system may use an object recognition application such as, the OpenCV framework to process the image information and determine one or more regions of interest (ROIs) within the image information. Each ROI may correspond with bounded region such as a rectangular region as will be described below and are illustrated by frames 206-x and may correspond with a body part(s) and/or regions of the user. Accordingly, after determining an ROI corresponding with a body of a patient 202, the system may frame this ROI with frame 206-1. Similarly, after determining ROIs corresponding with a foot and a hand of the patient, the system may frame these regions with, for example, frames 206-3 and 206-2, respectively.

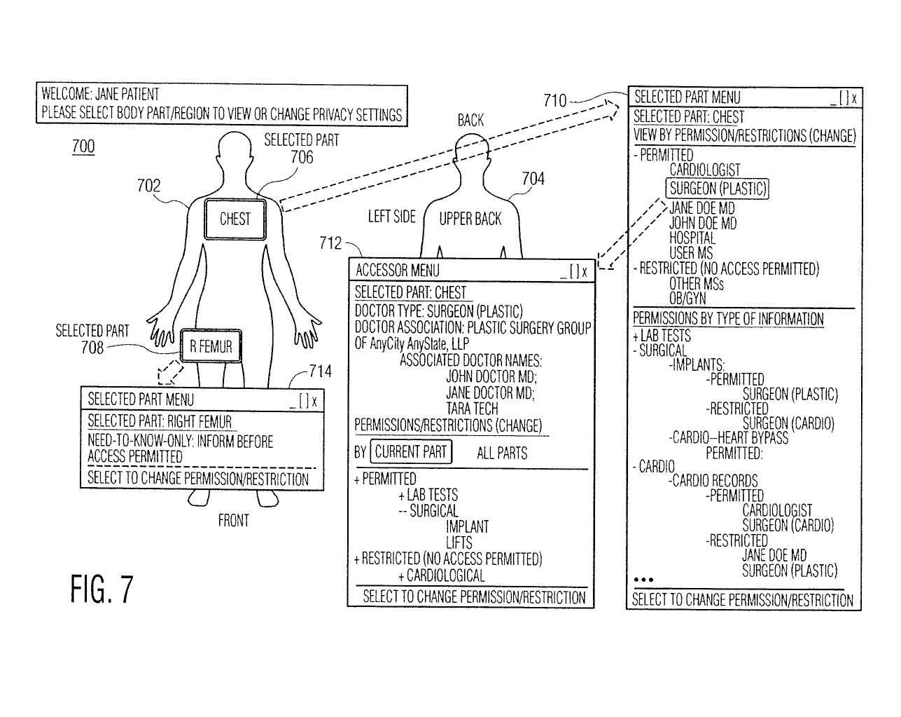

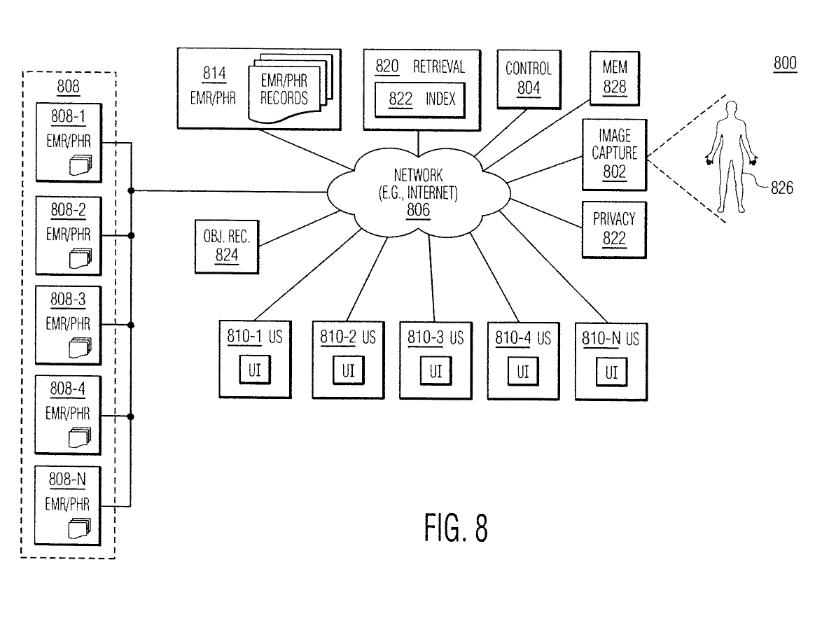

In the present example, the ROIs set forth by frames 206-x may correspond with bounded regions such as rectangular regions in accordance with the OpenCV™ HaarCascades recognition method and are illustrated by frames 206-1 through 206-3 (generally 206-x) which may, be at any position and/or scale within the image 200 and may, for example, correspond with a body, a right hand region, and a right thigh region, respectively, in the present example. However, as may be readily appreciated, other regions are also envisioned. In accordance with embodiments of the present system, the system may find all bounded regions within an image or sequence of images. For example, further rectangular regions may be located within the rectangular regions 206-x. Thus, for example, the right hand and right thigh rectangular regions 206-2 and 206-3, respectively, may be located within the body rectangular region 206-1. Within each bounded region (e.g., rectangular region 206-x), the object recognition portion 106 may determine various Haar-like features within the image. These Haar-like features may relate to a difference of the sum of pixels of areas inside a corresponding region of the image as will be described below with reference to FIG. 7. Haar-like features are described in further detail through the Internet at “en.wikipedia.org/wiki/Haar-like_features.”

To determine a location, shape, and/or size of an ROI, the object recognition portion may compare the image information of the user with standard object information (SOI) obtained, for example, from a memory of the system. Each ROI may have corresponding HaarCascades information included in, for example, a corresponding file of a suitable format such as an extensible markup language (XML), etc. Accordingly, in the present system, the SOI may include information which may define anatomical regions of a standard body. The system such as portions of the control portion 104, object recognition portion 106 and the retrieval portion 120 may obtain or otherwise utilize the HaarCascades information corresponding to body and/or parts thereof for purposes of identifying SBP and storing and retrieving EMR as described further herein. Thus, when the present system obtains an image sequence of a user, it may determine various information such as ROIs, various anatomical/body parts of the user in these regions, an interaction of defined body parts (i.e., first and second reference objects) of the user (e.g., user right hand upon right thigh, etc.), etc., in accordance with the HaarCascades information, and a duration of interaction between the defined body parts (e.g., an interaction time (Ti)). The system may then use this information (e.g., the interaction of the defined body parts and/or Ti) to determine one or more actions (e.g., retrieve a related EMR, etc.) in accordance with determined interaction and/or duration. It is also envisioned that information related to the interaction (e.g., right hand placed on right thigh) and/or duration of interaction (e.g., 10 seconds) may be output to other applications for further processing.

FIG. 3 shows an image 300 rendered using SOI in accordance with embodiments of the present system. Each of the circled areas of the image 300 may illustrate a standard object (e.g., a right hand, a left knee, etc.) corresponding with a predefined body part or other object and may be mapped to a human body on a one-to-one basis. The SOI may include images which may match a user such as a sitting image, a standing image, a running image, etc., such that the system may easily match image information of a use (e.g., captured via a web cam) with the corresponding SOI (e.g., sitting user may be matched with a sitting SOI file) such that the system may efficiently map the image information of the user with the SOI on, for example, the one-to-one basis. Further, with regard to body parts of the user, the body parts may refer to body parts, regions, and/or a system such as a lymphatic system, circulatory systems, cardiovascular system, etc., of a user in accordance with embodiments of the present system.

Referring to FIGS. 2 and 3, in accordance with embodiments of the present system, one or more parts of a body (e.g., one or more anatomical features) of a user in a sequence of captured images may be identified by determining one or more ROIs and corresponding regions and comparing these one or more regions with corresponding SOI information on a one-to-one basis to determine locations of standard objects (e.g., standardized anatomical features) and/or relationships between these standard objects to perform a recognition process for various anatomical features (e.g., facial features, head, abdomen, right hand, right foot, etc.) of one or more patients in the image. Thus, if several patients are in an image, the object recognition portion may distinguish each patient and may then distinguish anatomical features of each patient. Then, the process may match these features with the SOI so as to recognize patient body parts (e.g., head, abdomen, right hand, left foot, etc.). Accordingly, the process may automatically identify and/or verify a patient from a digital image using, for example facial features to identify the patient. The object recognition portion may process the image 200 using any suitable method (e.g., using a Haar classifier, imaging applications, etc.) to identify a patient, anatomical features of the patient and/or an interaction of the anatomical features of the patient.

To conserve resources, the SOI may be stored in different databases. For example, facial information may be stored in a facial SOI database while general body information may be stored in a body SOI database.

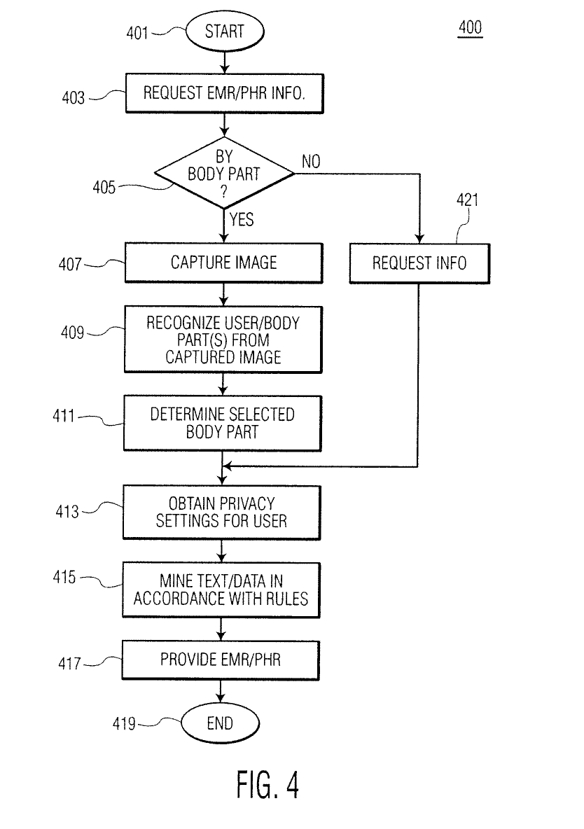

FIG. 4 shows a flow diagram that illustrates a process 400 in accordance with embodiments of the present system. The process 400 may be performed using one or more computers communicating locally and/or over a network including in embodiments of the present system one or more portions of the control portion 104, object recognition portions 106, etc. The process 400 may start during act 401 and then proceed to act 403. During act 403, the process may receive a request for EMR information from, for example, a requesting party/application (e.g., a doctor on a hospital work station, a doctor on a remote work station, etc.). The request may be input via, for example, a UI rendered on a display of the system (e.g., display 110, 930, etc.). The UI may include a windows-type display in which a user/patient/physician, etc., may enter a request. The request may include a request to process information by body part. After completing act 403, the process may continue to act 405.

During act 405, the process may determine whether the request for EMR information (e.g., see act 403) includes a request to be processed by body part. Accordingly, if it is determined that EMR information request is to be processed by body part, the process may continue to act 407. However, if it is determined that EMR/PHR information is not to be processed by body part, the process may continue to act 421.

With regard to act 421, the retrieval of desired information from the EMR/PHR database is performed using a different retrieval method (i.e., not based on identified body parts). In accordance with this embodiment, access to the desired information may still require obtaining privacy settings in accordance with the privacy settings of the user during acts 413, etc., as described further herein below or may be provided in accordance with other security systems as may be readily appreciated.

In a case wherein the request for EMR information is by body part (e.g., a yes during act 405), during act 407 the process may obtain image information of a patient. The image information may be obtained via, for example, a web cam, a camera of a user station such as a smart phone of a user, etc. The image information may include information related to a single image (e.g., a still or single image), a sequence of images (e.g., video images), etc., of the patient. For example, in accordance with embodiments of the present system, the camera may continuously capture images of a body of a patient within a specified frame rate (e.g., 20 images/sec). The images may be obtained for a predetermined time period (e.g., to 20 sec, etc.) or until a condition is met (e.g., the user is identified as a registered user, an ROI is determined, etc.) and/or may be sent to an object recognition portion for recognition (e.g., see, 106, FIG. 1). After completing act 407, the process may continue to act 409.

During act 409, the object recognition portion may recognize one or more is features of the image information. For example, the object recognition portion may identify the user and/or one or more body parts (e.g., right hand, left hand, abdomen, left shoulder, neck, head, etc.). To identify the patient, the object recognition portion may perform facial analysis using any suitable facial analysis technique on the image information of the patient to identify (ID) the patient (e.g., John Doe—registered patient). In accordance with embodiments of the present system, other systems for identifying the patient may be utilized alone and/or together with image analysis. The other systems may include a sampling of biometric information of the patent, such as fingerprint related biometrics, eye scans, etc. In embodiments of the present system, the patient may be identified via other authentication methods including username/password/pin in addition to or in place of the biometric information. After the patient is identified, the system may obtain information related to the identified patient such as stored image information of the patient (e.g., body images, facial images, body part images, etc.) etc., from a memory of the system to aid in the determination of the patient and/or parts of the patient using a suitable body recognition algorithm such as the OpenCV HaarCascade method. In identifying the one or more body parts, the object recognition portion may use a body recognition algorithm such as the OpenCV HaarCascade method to identify various body parts in the image such as head, face, arm (right/left), leg (right/left), chest, stomach, shoulder (right/left), etc., of the patient. After completing act 409, the process may continue to act 411.

During act 411, the system may determine a SBP of the patient. In accordance with embodiments of the present system, the SBP may be determined by identifying a relationship between two or more objects (e.g., two body parts, an object and a body part, etc.), a certain movement of a body part (e.g., shaking a leg), and/or by receiving an input from a patient.

With respect to selecting a body part of the patient by directly receiving an input from a party (e.g., user, physician, patient, technician, etc.), the party may select a body part by entering a name of the body part (e.g., “abdomen,” “head,” “right hand,” etc.), selecting a menu item (e.g., “abdomen,” “head,” etc.), and/or by highlighting a rendering of a body or parts thereof of the patient (or a generic body) using any suitable input method. For example, a party may point a stylus, press a touch screen, use a keyboard, mouse, an audio input, a gesture, etc. For example, is the process may render (e.g., display) an outline of a body (e.g., of the user) and a professional such as a doctor may highlight a desired body part which may then be designated a selected body part by the process. In accordance with embodiments of the present system, a professional such as a doctor treating a patient may select a body part of a patient even though the doctor and the patient may be at different physical locations by the selection based on a rendering of body parts.

In an embodiment of the present system wherein a body part of the patient is selected by identifying a relationship between two or more objects, this method may be selected manually and/or automatically. For example, upon identifying a patient as a recognized patient, the system may obtain patient setting information which may determine a preferred selection method (e.g., automatic or manual). Further, this method may be selected when an association between two or more objects such as body parts is identified, as will be described below.

The system may identify a relationship (e.g., an association) between two or more reference objects such as, a first object such as a body part of the patient and a second object such as another identified body part of the patient (e.g., hand) and/or a reference object (e.g., a stick, etc.), etc., over a period of time using a suitable object recognition algorithm and select the body part (e.g., corresponding with the first reference object) in accordance with the determined relationship of the first and second reference objects over time. For example, the system may determine from a sequence of images whether a second reference object such as a right hand of the patient has been placed over a first reference object such as an abdomen of the patient for a period of time which is greater than or equal to a corresponding threshold reference time (e.g., 5 seconds, etc.). Accordingly, when the system determines from a sequence of images that the second reference object has been placed over a first reference object for a period of time which is greater than or equal to a corresponding threshold reference time (e.g., 5 seconds, etc.), the system may set the first reference object as a selected body part. Accordingly, for example, when the system determines that the right hand of the patient has been placed on the head of the patient for a period of time which is greater than or equal to the threshold reference time (e.g., 5 seconds, etc.), the system may determine that the selected body part is the head. Associations of body parts for selection may be set by the system and/or the patient. An example of suitable systems for selecting body parts are described in U.S. patent application Ser. No. ______ (Attorney Docket No. FT07842). As may be readily appreciated, these systems or others may be applied in accordance embodiments of the present system.

After the present system determines a selected body part, it may continue to act 413. During act 413, the privacy settings of the patient may be obtained from a memory of the system. The privacy settings may include access rules and/or permissions for accessing the EMR information of the patient. For example, in a case wherein the patient is a registered patient, the privacy settings may be stored and/or associated with the patient in a memory (e.g., see, 108, 720, 822, etc.) of the system. Accordingly, if the patient is determined to be a registered patient (e.g., John Doe), the system may obtain the privacy settings that are associated with this patient from the memory. However, in a case wherein the patient is determined to be an unregistered patient, the system may use default privacy settings and/or request selection of one or more privacy settings (e.g., default, medical doctor access only, etc.). The privacy settings (e.g., for registered and/or unregistered patient) may be stored (e.g., in association with the patient) in a memory of the system and may include privacy settings for a plurality of patients and/or groups of patients including privacy settings related to parties requesting access to the patients EMR, location of the request (e.g., from office workstation, from home network, etc.). The privacy settings for each body part may include corresponding permissions and/or restrictions in accordance with a requesting entities type (e.g., the type of party requesting access to the EHR). The requesting entities type may relate to an identified person (e.g., users doctor), a type of professional (e.g., orthopedic surgeon), an application, and/or entity that may request and/or may access the EMR records of the user. The requesting entities may include, for example, the patient. However, other requesting entities types are also envisioned. With regard to the professionals, these may include a particular doctor (e.g., John Doe, M.D., etc.) and/or a type of doctor (e.g., a cardiologist, a surgeon, an OB/GYN, etc.). With regard to the application, this may relate to an application (e.g., a billing application, a medical image viewing application, etc.). With regard to entity, entities may include organizations (e.g., hospitals, clinics, emergency services (e.g., ambulances), etc.). Exemplary Permission/Restriction settings are illustrated in Table 1 below and may correspond with a user known as Jane Patient.

TABLE 1
Permissions Restrictions USER ID: JANE PATIENT

| | Accessor | | | | | | | | |
|---|---|---|---|---|---|---|---|---|---|
| | PROFESSIONALS (Doctor-Type OR ID) | | | | | | | | |
| | | Surgeon | | | Jane | John | Applications | | |
| | Cardi- | (plastic)/ | | OB/ | Doe | Doe | Users | | Entities: |
| Selected Object | ologist | (other) | Dentist | GYN | MD | MD | US | MSs | Hospital |
| Right Hand (RH) | no | yes/yes | no | no | yes | yes | yes | no | no |
| Right Shoulder (RS) | no | yes/yes | no | no | yes | yes | yes | no | no |
| Right Elbow(RE) | | yes/yes | no | no | yes | yes | yes | no | no |
| Right Thigh (RT) | no | yes/yes | no | no | yes | yes | yes | non | no |
| Right Knee (RK) | no | yes/yes | no | no | yes | yes | yes | no | no |
| Right Foot (RF) | no | yes/yes | no | no | yes | yes | yes | no | no |
| Left Hand (LH) | no | yes/yes | no | no | yes | yes | yes | no | no |
| Left Shoulder (LS) | no | yes/yes | no | no | yes | yes | yes | no | no |
| Left Elbow (LE) | no | yes/yes | no | no | yes | yes | yes | no | no |
| Left Thigh (LT) | no | yes/yes | no | no | yes | yes | yes | no | no |
| Left Knee (LK) | no | yes/yes | no | no | yes | yes | yes | no | no |
| Left Foot (LF) | no | yes/yes | no | no | yes | no | yes | no | no |
| Head | yes | yes/yes | yes | no | yes | no | yes | no | no |
| Abdomen | yes | yes/yes | no | yes | yes | no | yes | no | no |
| Neck | yes | yes/yes | yes | no | yes | no | yes | no | no |
| Chest | yes | yes/yes | no | no | yes | no | yes | no | yes |

With respect to the requesting entities, Table 1 is configured such that an OB/GYN may access EMR/PHR information related to a body part such as abdomen of the patient while a dentist cannot access this information. Similarly, a cardiologist may access EMR/PHR information related to selected body parts such as the head, abdomen, neck, and chest of the patient while access to the same information may not be permitted by a plastic surgeon. Rather, the plastic surgeon may only be allowed to access information related the chest of the patient. Moreover, the accessible information may be further restricted by body part and type of information. For example, the patient and/or system may further restrict EMR/PHR information such that the surgeon may only access implant information related to the chest while the cardiologist may only access cardio-vascular information related to the chest. Further, the system may restrict access based upon whether the requesting entity is determined to be a treating physician or a non-treating physican. Moreover, the patient may include privacy settings for selected physicians such as Drs. John and Jane Doe as well as acceptable locations for accessing the EMR. For example, a privacy setting may enable a treating physician to access the filtered EMR at a hospital work station but not allow the treating physician to access the filtered EMR is on a remote (e.g., home) work station, etc. In accordance with embodiments of the present system, a menu may be provided for a party to select, change, and/or set and may update the privacy settings of the patient's EMR in accordance with the party's selections. For example, the system may render a menu in which the patient may set, select, and/or change privacy settings.

After completing act 413, the process may continue to act 415. During act 415, the process may retrieve patient data from an EMR database (e.g., in the EMR database portion) in accordance with an identification of a patient, the identified body part, and the patients privacy settings. Accordingly, the process may query the EMR database portion in accordance with rules including one or more of the ID of the patient, the selected body part or parts, and a corresponding privacy setting. The query may be formed by the process such that it corresponds with a suitable querying format such as an executable SPARQL semantic query. The query may then be transmitted to a server of the EMR database portion from a requesting server and the query results may be transmitted from the EMR database portion to, for example, the requesting server. Although a query request/response example is disclosed, other methods of mining one or more databases for information are also envisioned.

By identifying the patient and forming a query of information related to the patient, unauthorized access and/or mining of data of EMR of patients other than approved by the identified patient can be prevented. Accordingly, based upon the patient identity and associated privacy settings (e.g., permissions/restrictions, etc.), the EMR database portion may provide medical records associated with the specific body part stored (or obtained e.g., from another memory, etc.) in the EMR database portion. Accordingly, the process may determine a selected body part and mine/filter EMR data to obtain a filtered portion of the EMR which corresponds with the selected body part from the EMR. Accordingly, for example, if the image recognition portion identifies a patients chest as a selected body part, and identifies the patient as Mike Johnson (or recognizes the patient using an alpha and/or numerical identifier (e.g., patient 123456A, etc.), it would associate “chest,” with “Mike Johnson” and perform a corresponding search of Mike Johnson's EMR to obtain relevant records of Mike Johnson which are associated with the chest. Accordingly, the process may retrieve data in accordance with a recognized body part and the privacy settings associated with, for example, “Mike Johnson” and obtain a portion of the EMR (e.g., medical is data) associated with Mike Johnson's chest. In accordance with embodiments of the present system, the retrieved portion of the EMR may then transmitted to a requesting party such as a user station (US) of a medical professional, etc. After completing act 415, the process may continue to act 417.

During act 417, the process may provide the filtered EMR (e.g., the query results) to a requesting entity (e.g., at a requesting server, a US, etc.). Then, the filtered EMR may be rendered on a UI of the system such as display of a US of a requesting entity, such as a medical professional, etc. Accordingly, in the present example, a portion of Mike Johnson's EMR related to his chest data including heart ailments, previous surgeries, history of electrocardiograms, etc. may be accessed and/or viewed by the requesting entity. The process may also store the filtered EMR in a memory of the system for later use.

Further, in accordance with embodiments of the present system and with regard to the EMR, this information may be structured (e.g., stored in the EMR database portion) in portions corresponding to the body parts and/or by linking a body part and corresponding portions of the EMR to one or more underlying body structures, systems (e.g., lymphatic, respiratory, cardiovascular, nervous etc.) Accordingly, when the system accesses the EMR of a patient, if a selected body part is the chest and the requesting entity is identified as a doctor by type as a cardiologist, then the system may access and render a portion of the EMR related to for example, cardiovascular structures in the chest (e.g., heart, veins, arteries, etc.) such as MRIs, EKGs, and/or underlying systems such as circulatory system, etc. In a similar fashion, if the selected body part is still the chest, and the doctor is identified by type as a plastic surgeon, then the system may access and/or render filtered EMR related to, for example, plastic surgery in the chest region of the user and may return the filtered EMR related to, for example, breast implants, etc., of the identified user.

As may be readily appreciated, in accordance with embodiments of the present system, examination time may be reduced by forwarding the filtered EMR of a patient in accordance with a SBP and privacy settings without a need for the requesting entity to sift through what is oftentimes volumes of information related to the patient's medical history while also maintaining the privacy of the patient by not returning portions of the EMR that the patient prefers be withheld.

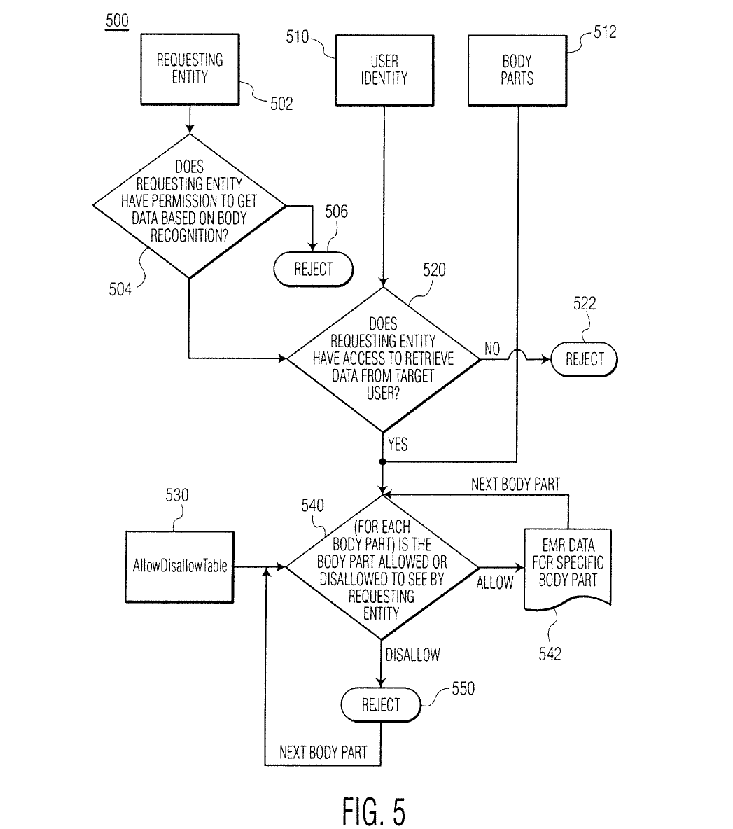

FIG. 5 shows a flow diagram that illustrates a process 500 in accordance with embodiments of the present system. The process 500 may be performed using one is or more computers communicating over a network and illustrate how different portions of the system interact to provide the rules for filtering of a patients EMR. In accordance with embodiments of the present system, the rules for accessing the filtered EMR may be decided based on rules related to three portions of the present system. In a first portion 502, a requesting entity making a request for a filtered EMR is identified. In a second portion 510, the identity of the patient is determined as discussed herein. In a third portion 512, a SBP of the patient may be determined as discussed herein.

During act 504, the request by the requesting entity may be input via, for example, a UI rendered on a display of the system. The UI may include a windows-type display in which a user may enter a request. The request may include a request to process information by body part. As stated above, the requesting entity may be the patient, a doctor, hospital, imaging technician, etc., each of which or some portion thereof, may have associated privacy setting. Each of these portions may have further privacy settings that interact such as the setting related to the technician obtaining patient image information for making the request as well an authority of a physician that made the request of the technician, the location of the requesting physician (e.g. the requesting site), etc. The privacy settings related to the patient EMR, the requester, etc., related to permission to access the EMR based on a body recognition request for the EMR from, for example, a requesting party/type/application (e.g., a doctor, a medical service provider, etc.) may be examined to determine whether the requesting entity has permission to access the EMR based on body recognition (or otherwise). In accordance with embodiments of the present system, the request to access the EMR may also include security credentials for example an identification of the requester, as well as other information such as date, time of day, geolocation of server, and/or other information to provide context (e.g., is the request made from your doctors office, from a hospital, etc.) to the request. The request may be input via, for example, a UI rendered on a display of the system. The UI may include a windows-type display in which a user may enter a request. The request may include a request to process information by body part. In a case wherein the requester does not have permission to access the patients EMR by body part, the request is rejected during act 506 and the process terminates.

In a case wherein the requester does have permission to access the patients EMR by body part, the process may continue to act 520. During act 520, it is is determined whether the requesting entity has permission, based on privacy settings associated with the target patient, requesting entity, etc., to access the EMR of the patient. In a case wherein the requester does not have permission to access the target patients EMR, the request is rejected during act 522 and the process terminates. In a case wherein the requester does have permission to access the target patients EMR, it is determined during act 540 for each identified SBP, whether access is allowed or disallowed. An allow/disallow table 530 may be utilized similar as table 1 herein to make the determination. Based on whether access to the EMR related to a SBP is allowed or disallowed, the filtered EMR for the body part is provided during act 542 or rejected during act 550 as allowed/disallowed.

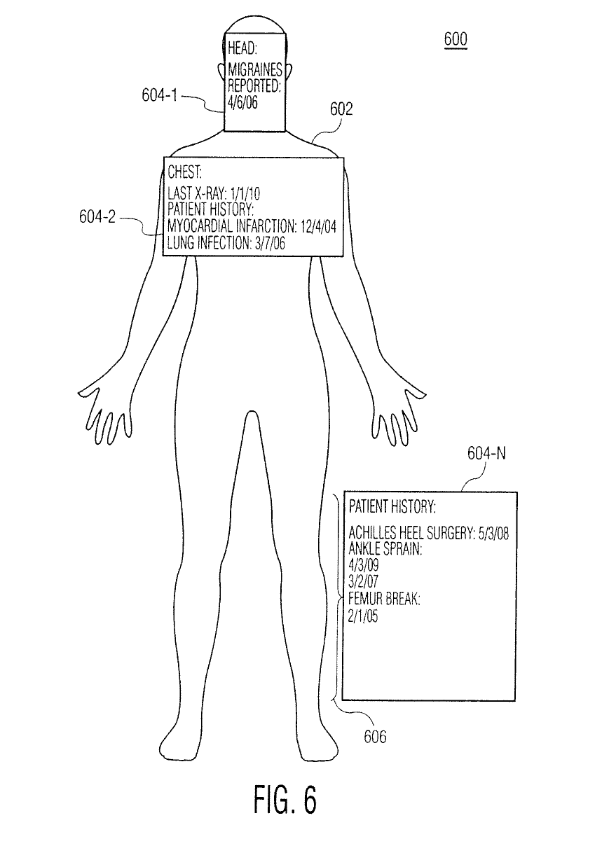

FIG. 6 shows an illustrative mapping 600 of EMR to body parts of a patient 602 in accordance with embodiments of the present system. The EMR may include information such as medical records 604-1 through 604-N of the patient which may be mapped/indexed (e.g., by the system) to a corresponding body part of the patient. In accordance with embodiments of the present system, the mapping may be performed by a retrieval/indexer portion 120, 122 as shown in FIG. 1. The mapping may include a one-to-one mapping wherein for example, medical record 604-1 may be mapped to a head of the user; medical record 604-2 may be mapped to a chest of the user, etc. However, the mapping may also include a mapping of a selected body part to several regions, if desired. For example, with respect to medical record 604-N, this record may be mapped to a region such as a region which may include one or more of a thigh, leg, and/or foot of the user. Accordingly, after a body part is identified, the system may refer to a look-up table to determine a mapping of medical records to SBPs such that once a SBP is identified, the filtered EMR may be provided as long as privacy criteria are met (e.g., the requesting entity has authorization for viewing the filtered EMR or portions thereof in a case wherein the requesting entity only has authorization to receive a portion of the filtered EMR). The allow/disallow table 530 shown in FIG. 5 illustrates how a requesting entity may be provided access to the filtered EMR or portions thereof. Further, with regard to SBPs, the SBPs may refer to body parts, regions, and/or a system such as a lymphatic system, circulatory systems, cardiovascular system, etc., of the patient in accordance with embodiments of the present system. For example, an identification of a SBP of the chest may retrieve the portion of the filtered EMR 604-2 for a cardiologist requesting entity, such as the last x-ray and myocardial infarction records but for a pulmonologist requesting entity, the myocardial infarction and lung infection records may be retrieved. In this way, a simple access to the EMR is provided that is relevant to a given requesting entity while respecting privacies of the patient. In another mapping/indexing, an identification of a SBP may result in retrieval of a filtered EMR related to an underlying body system, such as a retrieval of lymph node biopsies for a oncologist requesting entity.

FIG. 7 shows a mapping/indexing 700 of privacy settings to body parts of a patient in accordance with embodiments of the present system. The mapping/indexing 700 may be rendered on a display of the system and may include an outline of a patient such as, for example, front and back outlines 702 and 704, respectively, and/or other outlines (e.g., right side, left side, top, bottom, sagittal view, etc.). The patient may view his/her privacy settings for a selected body part by, for example, highlighting a desired body part, region, etc. on a corresponding outline (e.g., see, 702, 704) as illustrated by highlight frames 706 and 708. Accordingly, upon determining that a body part, region, etc. has been selected by the patient, the system may display corresponding privacy settings for the selected body part, region, etc. For example, with respect to the selected chest area (e.g., see area frame 706), the system may render a corresponding selected part menu 710 which may include permissions/restrictions for the selected part. The system may also provide more detailed information when certain parts of the selected (e.g., by highlighting, etc.) part menu 710 are selected. The patient may then view and/or change settings, if desired. For example, upon selecting (e.g., by highlighting Surgeon (plastic), etc.), the system may render a corresponding accessor menu 712 which may provide further information such as permission/restriction information for the selection (e.g., Surgeon (plastic)). Moreover, the patient may view permission by type of information. For example, with respect to the selected part (e.g., the Chest in the current example), the system may determine default and/or available record types (e.g., Lab Tests, Surgical, Cardio, etc.) and/or subtypes (e.g., see Implants, etc.), and show corresponding access permissions/restrictions.

The patient may then select desired items to change and/or may change these items. The system may then update corresponding user information (e.g., see Table 1) and store the updated information in a memory of the system. The system may also perform a check to determine that settings are not inconsistent and/or may inform a user when inconsistent settings are determined and await a user input. The is system may also automatically correct inconsistent inputs when detected.

With respect to selected area 708, the system may display a selected part menu 714 which is similar to the selected part menu 710, which illustrates a setting for a need-to-know access permission. Thus, if an accessor attempts to access EMR information related to the Right Femur of the patient (e.g., patient, Jane Patient), the system may determine that access to a filtered EMR related to this body part is restricted and only permit access if the patient (e.g., Jane Patient in the present example) specifically allows access to a selected requesting entity. Accordingly, the system may inform (e.g., by sending a text message, rendering message, etc.) informing the patient of the attempted access to the filtered EMR and the requesting entity. The patient may then grant or deny access to the requesting entity (or other selected parties). Accordingly, if the system determines that access has been granted, then the system may provide the filtered EMR related to the selected body part to the accessor or accessors which were granted permission to view the filtered EMR. However, if access to the filtered EMR was denied, the system may information the accessor that permission has been denied and/or offer the requesting entity other options such as an additional request to access information, etc. The system may also provide an override for emergency services. Accordingly, the system may provide authorized users to override restrictions to access the filtered EMR of a patient, if requested.

Accordingly, the system may render a privacy mapping of privacy settings corresponding with all body parts, regions, etc., if selected by the patient. Moreover, the privacy settings may include dates and/or time restrictions (e.g., chest previous month only; head 2 past two years, etc.). The date/time restrictions may be dependent upon body part, a type of record, the requesting entity, etc.

FIG. 8 shows a portion of a system 800 in accordance with embodiments of the present system. The system 800 may include one or more of an image capture portion 802, a control portion 804, a network portion 806, an EMR/PHR database portion 814, a retrieval portion 820, an EMR/PHR portion 808, a privacy portion 822, an object recognition portion 824, a memory portion 828, and user station portions (USs) 810 one or more of which (or portions of which) may be combined with each other and/or may be operatively coupled to each other using a suitable wired and/or wireless connection such as the network 806.

The network 806 may include any suitable network or networks such as a local is area network (LAN), a wide area network (WAN), a personal area network (PAN), the Internet, a telephony network, a wireless network, a peer-to-peer network, etc. The network 806 may include one or more servers and/or memories portions such as a cloud memory a surface area network (SAN), etc. The control portion 804 may control the overall operation of the system 800 and may include one or more logic devices, processors, application specific integrated circuits (ASICs), controllers, logic arrays, etc. which may be hardware and/or software controlled. Accordingly, the control portion 804 may run one or more applications, computer programs, etc., so as to perform one or more processes and/or act listed herein. The memory 828 may include a general memory of the system 800 and may store applications, computer programs, settings, and/or information generated by the present system such as logfiles, etc.

The image capture portion 802 may include an image capture device such as a camera, a video camera, etc., which may capture one or more images of a user 826 and may forward the captured information (e.g., in digital and/or analog form) to the control portion 804 for further processing. Accordingly, the image capture portion 802 may include, for example, a camera of a US 810-x, a web cam, a digital camera, a digital video recorder, a scanner, etc. Object recognition portion 824 may receive the image information and may use a suitable object recognition algorithm (e.g., HaarsCascade, etc.) to recognize SBPs of a patient and forward this information to the control portion 804.

The privacy portion 822 may include information related to one or more users of the present system such as account information, privacy information, accounting, authorization, and access (AAA) information, etc. Accordingly, the privacy portion 822 may store privacy information of one or more patients such as Jane Patient, etc., and information related to requesting entities. The privacy portion 822 may be operative to determine whether the filtered EMR may be accessed by the present system and/or transmitted to one or more USs 810-1 through 810-N.

The EMR/PHR portion 808 may include one or more memories 808-1 through 808-N which may store one or more electronic medical records and/or personal health records for one or more users. Accordingly, the EMR/PHR portion 808 may include, for example, a patient database of a medical service provider such as a hospital (e.g., see memory 808-1), a doctor's office (808-2), a clinic (808-3), a client is database of a (e.g., health) insurance company 808-4, a national medical database (e.g., 808-N), etc. Further, each of the EMR/PHR memories 808-12 through 808-N may include a relationship memory which may include, for example, information about the corresponding medical service provider such as services offered (e.g., CAT scans, MRI, etc.) and/or biographic and/or other information of one or more service providers such as doctors, surgeons, technicians, staff, etc. Accordingly, the EMR/PHR portion 808 may include external databases, etc.

The retrieval portion 820 may include an index portion 822 and may search (e.g., by querying etc.) the EMR/PHR portion 808 periodically and/or non-periodically for electronic medical and/or personal health records of one or more users (e.g., registered users, etc.) of the present system. Results of the scan (e.g., results of the query) may be indexed by the indexer 822 and stored in the EMR/PHR db portion 814 for later use. Accordingly, information (e.g. EMR/PHR, etc.) related to one or more patients (e.g., registered patients, etc.) may be stored using a suitable format (e.g., a SPARQL format) in the EMR/PHR database portion 814 for later use. In other embodiments, when additional portions of a given patients EMR is added to, this information may be automatically forwarded to the indexing 822 for indexing/mapping to SBPs of the patient.

The USs 810-1 through 810-N may include a user interface (UI) with which a user may interact with the corresponding US. The USs 810-x may include any suitable communication device such as a mobile station (MS), a cellular phone, a mobile phone, a smart phone (e.g., an IPhone™), a soft phone, a personal computer (PC), a netbook, a laptop, a messaging device (e.g., a Blackberry™, etc.), a pad-type computing device (e.g., an iPad™, etc.), a medical imaging device, etc. and which may render information on a display such as EMR/PHR of a user.

During operation of the system 800, the system may receive a request from an US such as the US 810-1 belonging to a first user (or another user 810-2 through 810-N) to acquire image information corresponding with an image or sequence of images of the same or another user (e.g., the patient) such as the patient 826. The request may include requesting entity information (REI) which may identify a requesting US of the plurality of USs 810-x as well as an identification of the requesting entity. The image information may then be processed by the object recognition portion 824 which may identify the patient (e.g., using facial analysis) as a registered patient (e.g., Jane Patient) and/or may identify the party operating the is image capture portion 802. The system may then access the privacy information of the patient and obtain settings of the identified patient (e.g., first and second object associations, permissions/restrictions, etc.). However, if the patient is identified as a non-registered patient, the system may obtain default privacy settings. The system may then identify a selected body part of the patient in accordance with the associated privacy settings. The system may determine permissions/restrictions based upon the privacy settings of the patient and may access the filtered EMR from, for example, the EMR/PHR database portion 814 and/or the EMR/PHR portion 808, in accordance with the privacy settings of the identified patient 826 and/or the REI. Accordingly, the retrieval portion 820 may form, for example, a natural language search query in accordance with the selected body part and privacy settings of the patient and the REI and transmit the search query to a server of the EMR/PHR database 814. Then, the server of the EMR/PHR database portion 814 may return results of the query (e.g., the filtered EMR/PHR of the patient 826). The control portion 804 may then forward the filtered EMR/PHR to one or more selected USs which may be identified by the REI such as US 810-2 (e.g., of a surgeon) in accordance with the privacy settings of the patient 826. The filtered EMR/PHR information may be displayed on, for example, a UI of the selected US 810-2.

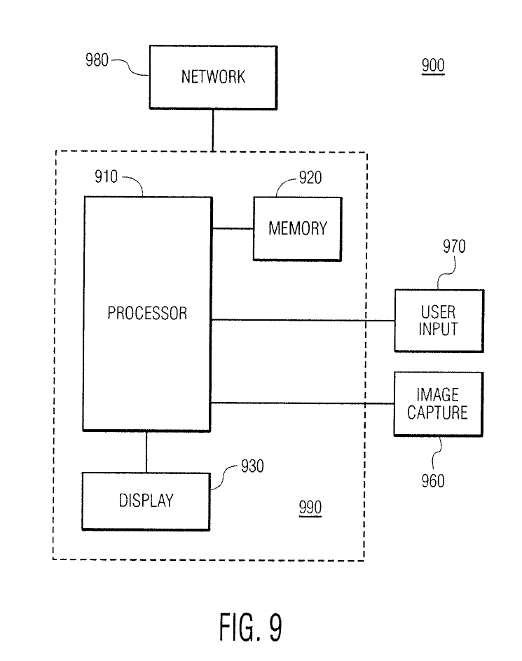

FIG. 9 shows a portion of a system 900 (e.g., control portion, retrieval portion, object recognition portion, image capture portion, etc.) in accordance with embodiments of the present system. For example, a portion of the present system may include a processor 910 operationally coupled to a memory 920, a display 930, an image capture portion 960, and a user input portion 970. The image capture portion 960 may include any suitable imaging device such as, for example, a camera, a video camera, a live stream, an x-ray device, computed tomography (CT scan), sonogram, and/or other imaging system, which may provide one or more images of one or more patients. The memory 920 may be any type of non-transitory device for storing application data as well as other data related to the described operation. The application data and other data are received by the processor 910 for configuring (e.g., programming) the processor 910 to perform operation acts in accordance with the present system. The processor 910 so configured becomes a special purpose machine particularly suited for performing in accordance with the present system.

The operation acts may include requesting, providing, and/or rendering of patient's EMR or filtered portions thereof. The user input portion 970 may include a keyboard, mouse, trackball or other device, including touch sensitive displays, which may be stand alone or be a part of a system, such as part of a personal computer, personal digital assistant, mobile phone, set top box, television or other device for communicating with the processor 910 via any operable link. The user input portion 970 may be operable for interacting with the processor 910 including enabling interaction within a UI as described herein. Clearly the processor 910, the memory 920, display 930 and/or user input device 970 may all or partly be a portion of a computer system or other device such as a client and/or server as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 920 or other memory coupled to the processor 910.

The program and/or program portions contained in the memory 920 configure the processor 910 to implement the methods, operational acts, and functions disclosed herein. The memories may be distributed, for example between the clients and/or servers, or local, and the processor 910, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 910. With this definition, information accessible through a network is still within the memory, for instance, because the processor 910 may retrieve the information from the network for operation in accordance with the present system.

The processor 910 is operable for providing control signals and/or performing operations in response to input signals from the user input portion 970, the image capture portion 960, as well as in response to other devices of a network and executing instructions stored in the memory 920. The processor 910 may be an application-specific or general-use integrated circuit(s). Further, the processor 910 may be a dedicated processor for performing in accordance with the present system or may be a general-purpose processor wherein only one of many functions operates for performing in accordance with the present system. The processor 910 may is operate utilizing a program portion, multiple program segments, and/or may be a hardware device utilizing a dedicated or multi-purpose integrated circuit. The image capture portion 970 may capture images of one or more users as still and/or video information and may provide the captured image information to the processor 910.

Thus, in accordance with embodiments of the present system, an imaging system, such as a camera, x-ray device, electro-magnetic imaging device, etc., may capture images of a patient and form corresponding image information. The system may use an object recognition method to identify the person and/or determine one or more SBPs of the patient. The system may then access an EMR/PHR, which may include an Electronic Medical Record (EMR) and/or Personal Health Record (PHR) of the patient, and obtain information in accordance with SBP and/or a privacy setting corresponding with the patient. This information obtained by the system may then be rendered by the system. The EMR and PHR may include a medical and/or health summary of the patient including the personal details, and permissions about various entities who are allowed to see the data associated with the body part. The privacy setting may include actions which may be permitted or not permitted. The actions may be related to a body subsystem, body part, etc., a user (e.g., a doctor, entity, organization, individuals, patient, etc.), etc. For example, a privacy setting may include a geo/time dimension, such as a location of the requesting entity (e.g., country, region, or simply a geolocation), a time of the request (e.g., date, time), an expiration time for the request (e.g. how long is the information needed for/how long does the requesting entity have rights to view the filtered EMR), etc. The privacy setting may apply to body parts which may be selected, actions which may be related to the body part and/or to a user, patient, etc. For example, permission to obtain or access records related to a certain body part may be restricted. Moreover, access to the filtered EMR may be restricted in accordance with an entity (e.g., a doctor, organization, individual, type of professional, etc.) which may view the filtered EMR. The system and/or a person (e.g., patient) may define, set and/or change privacy settings so as to reflect a desired privacy setting. Accordingly, a patient may define privacy settings which may be narrower or broader. In accordance with embodiments of the present system, privacy settings may be set by the patient, medical organization, legal entity, and/or country/region/government. Further, privacy settings may be defined on a website, and/or by a legally sanctioned process, by petition, on a patients' behalf (e.g., by a caretaker, legal guardian, etc.), etc.

Further variations of the present system would readily occur to a person of ordinary skill in the art and are encompassed by the following claims. Through operation of the present system, a virtual environment solicitation is provided to a user to enable simple immersion into a virtual environment and its objects.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices, acts, etc., or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

What is claimed is:

1. A method of retrieving an electronic medical record (EMR) of a patient, the method controlled by one or more controllers and comprising acts of:
obtaining image information of the patient;
analyzing the image information using an object recognition method;
identifying a selected body part (SBP) of the patient based upon the analyzing of the image information; and
retrieving a filtered EMR of the patient in accordance with the SBP.

2. The method of claim 1, further comprising an act of providing the retrieved filtered EMR to a requesting user station (US).

3. The method of claim 1, wherein the act of retrieving is performed in accordance with a privacy setting of the patient.

4. The method of claim 3, wherein the privacy settings comprise settings related to one or more of the SBP and a requesting entity.

5. The method of claim 1, wherein the identifying is further performed in accordance with a determined relationship between two or more body parts of the patient.

6. The method of claim 5, wherein the act of determining the relationship further comprises acts of:
recognizing a plurality of body parts of the patient from the image information using an optical recognition technique; and
determining an association between two or more of the recognized body parts.

7. The method of claim 1, further comprising an act of rendering the filtered EMR on a display.

8. The method of claim 1, further comprising an act of determining whether the patient is a registered patient based upon a biometric analysis of features of the patient.

9. A system to retrieve a portion of an electronic medical record (EMR), the system comprising:
a processor portion which:
obtains image information of a patient;
analyzes the image information using an object recognition method;
identifies a selected body part (SBP) of the patient based upon the analyzing of the image information; and
retrieves a filtered EMR of the user in accordance with the SBP.

10. The system of claim 9, wherein the processing portion provides the retrieved filtered EMR to a requesting user station (US).

11. The system of claim 9, wherein the processing portion retrieves the filtered EMR of the patient in accordance with a privacy setting of the patient.

12. The system of claim 11, wherein the processing portion obtains privacy settings related to one or more of the SBP and a requesting entity.

13. The system of claim 9, wherein the processing portion:
determines a relationship between two or more body parts of the patient; and
identifies the SBP based upon the determined relationship.

14. The system of claim 13, wherein the processing portion:
recognizes a plurality of body parts of the patient from the image information using an optical recognition technique;
determines an association between two or more of the recognized body parts; and
determines the relationship based upon the determined association between the two or more recognized body parts.

15. The system of claim 9, further comprising a display which renders the filtered EMR.

16. The system of claim 9, wherein the processing portion:
performs a biometric analysis of features of the patient; and
determines whether the patient is a registered patient based upon the biometric analysis.

17. A computer program stored on a non-transitory computer readable memory medium, the computer program configured to retrieve a portion of an electronic medical record (EMR), the computer program comprising a program portion configured to:
obtain image information of a patient;
analyze the image information using an object recognition method;
identify a selected body part (SBP) of the patient based upon the analyzing of the image information; and
retrieve a filtered EMR of the patient in accordance with the SBP.

18. The computer program of claim 17, wherein the program portion is configured to provide the retrieved filtered EMR to a requesting user station (US).

19. The computer program of claim 17, wherein the program portion is configured to retrieve the filtered EMR in accordance with a privacy setting of the patient.

20. The computer program of claim 17, wherein the program portion is configured to obtain privacy settings related to one or more of the SBP and a requesting entity.

21. The computer program of claim 17, wherein the program portion is configured to:
determine a relationship between two or more body parts of the patient; and
identify the SBP based upon the determined relationship.

22. The computer program of claim 21, wherein the program portion is configured to:
recognize a plurality of body parts of the patient from the image information using an optical recognition technique;
determine an association between two or more of the recognized body parts; and
determine the relationship based upon the determined association between the two or more recognized body parts.

23. The computer program of claim 17, wherein the program portion is configured to render the filtered EMR on display.

24. The computer program of claim 13, wherein the program portion is configured to:
perform a biometric analysis of features of the patient; and
determine whether the patient is a registered patient based upon the biometric to analysis.

25. A method of filtering electronic medical record (EMR) of a patient, the method comprising acts of:
determining a selected body part (SBP) of the patient;
obtaining a privacy setting of the patient, the privacy setting including privacy settings related to the SBP;
filtering the EMR in accordance with the selected body part and the privacy setting of the patient.

26. The method of claim 25, wherein the act of filtering the EMR further comprises forming a query in accordance with the determined SBP and the privacy setting of the patient.

27. The method of claim 26, wherein the act of filtering the EMR further comprises querying an EMR database in accordance with the formed query.

28. The method of claim 27 wherein the act of filtering the EMR further comprises receiving results of the query and forwarding the results of the query to one or more selected user stations.
